(19) United States
(12) Patent Application Publication
(10) Pub. No.: US 2010/0031933 A1
(43) Pub. Date: Feb. 11, 2010

(54) SYSTEM AND ASSEMBLIES FOR HOT WATER EXTRACTION TO PRE-HEAT FUEL IN A COMBINED CYCLE POWER PLANT

(76) Inventors: Prakash Narayan, Chennai (IN); Shinoj Vakkayil Chandrabose, Thrissur (IN)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/185,955

(22) Filed: Aug. 5, 2008

(51) Int. Cl. F02G 5/00

(52) U.S. Cl. 123/543

(57) ABSTRACT

A system and assemblies for a fuel supply system are provided. The system includes a water heater assembly configured to heat a flow of water by mixing progressively higher grade heated flows of at least one of steam and water from a multi-stage heat exchanger arrangement, a fuel inlet flow path configured to receive a flow of fuel, and a fuel heater including a first flow path coupled in flow communication with the fuel inlet flow path and a second flow path coupled in flow communication with the water heater assembly wherein the fuel heater is configured to transfer heat from the flow of water to the flow of fuel.

### BACKGROUND OF THE INVENTION

This invention relates generally to power generation systems and, more particularly, to a system and assemblies for pre-heating fuel in a combined cycle power plant.

At least some known power generation systems include a multi-stage heat recovery steam generator (HRSG) configured to generate progressively lower grade steam from each successive stage in the exhaust of a gas turbine engine. Relatively high grade heat at a gas inlet to the HRSG is capable of generating relatively high pressure steam in a high pressure stage or section of the HRSG. After heat is removed from the gas in the high pressure stage the gas is channeled to an intermediate pressure stage where the relatively cooler gas is only capable of generating a relatively lower pressure or intermediate pressure steam.

To reduce the fuel consumption in the gas turbine engine the fuel is typically preheated. The preheating of the fuel uses one or more water flows from respective HRSG sections to heat the fuel in a multi-stage fuel heater. However, the amount of heat addition to the fuel using a single stage or multistage fuel heater is limited.

### BRIEF DESCRIPTION OF THE INVENTION

In one embodiment, a fuel supply system includes a water heater assembly configured to heat a flow of water by mixing progressively higher grade heated flows of at least one of steam and water from a multi-stage heat exchanger arrangement, a fuel inlet flow path configured to receive a flow of fuel, and a fuel heater including a first flow path coupled in flow communication with the fuel inlet flow path and a second flow path coupled in flow communication with the water heater assembly wherein the fuel heater is configured to transfer heat from the flow of water to the flow of fuel.

In another embodiment, a water heater assembly is configured to heat a flow of water by mixing progressively higher grade heated flows of at least one of steam and water from a multi-stage heat exchanger arrangement. The water heater assembly includes an inlet configured to receive a flow of condensate water from a relatively lower pressure heat exchanger positioned in the multi-stage heat exchanger arrangement and a flash tank mixing vessel that includes a plurality of inlet flow paths and an outlet. The flash tank mixing vessel is configured to receive a flow of at least one of steam and water from a respective heat exchanger in the multi-stage heat exchanger arrangement coupled in flow communication to each of the plurality of inlet flow paths.

In yet another embodiment, a fuel heater assembly is configured to heat a flow of water by mixing progressively higher grade heated flows of at least one of steam and water from a multi-stage heat exchanger arrangement. The fuel heater assembly includes a water heater assembly that includes a plurality of inlet flow paths configured to receive a flow of at least one of water and steam from respective heat exchangers positioned in the multi-stage heat exchanger arrangement wherein the respective heat exchangers correspond to a plurality of different grades of heat in the multi-stage heat exchanger arrangement. The water heater assembly also includes an outlet configured to channel the heated flow of condensate from the water heater assembly. The fuel heater assembly also includes a fuel heater that includes a first flow path configured to be coupled in flow communication with a flow of fuel, and a second flow path configured to be coupled in flow communication with the outlet wherein the fuel heater is configured to transfer heat from the flow of water to the flow of fuel.

### BRIEF DESCRIPTION OF THE DRAWINGS

FIGS. 1 and 2 show exemplary embodiments of the system and assemblies described herein.

FIG. 1 is a schematic diagram of an exemplary combined cycle power generation system; and

FIG. 2 is a schematic diagram of the water heater assembly, shown in FIG. 1, in accordance with an exemplary embodiment of the present invention.

### DETAILED DESCRIPTION OF THE INVENTION

The following detailed description illustrates embodiments of the invention by way of example and not by way of limitation. It is contemplated that the invention has general application to improving efficiency of combustion and power generation systems by using progressively higher grade heat to preheat a fuel flow to a combustor in industrial, commercial, and residential applications. As used herein high grade heat refers to heat at a relatively high temperature, low grade heat refers to heat at a relatively low temperature, and intermediate grade heat refers to heat at a temperature between that of low and high grade heat.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

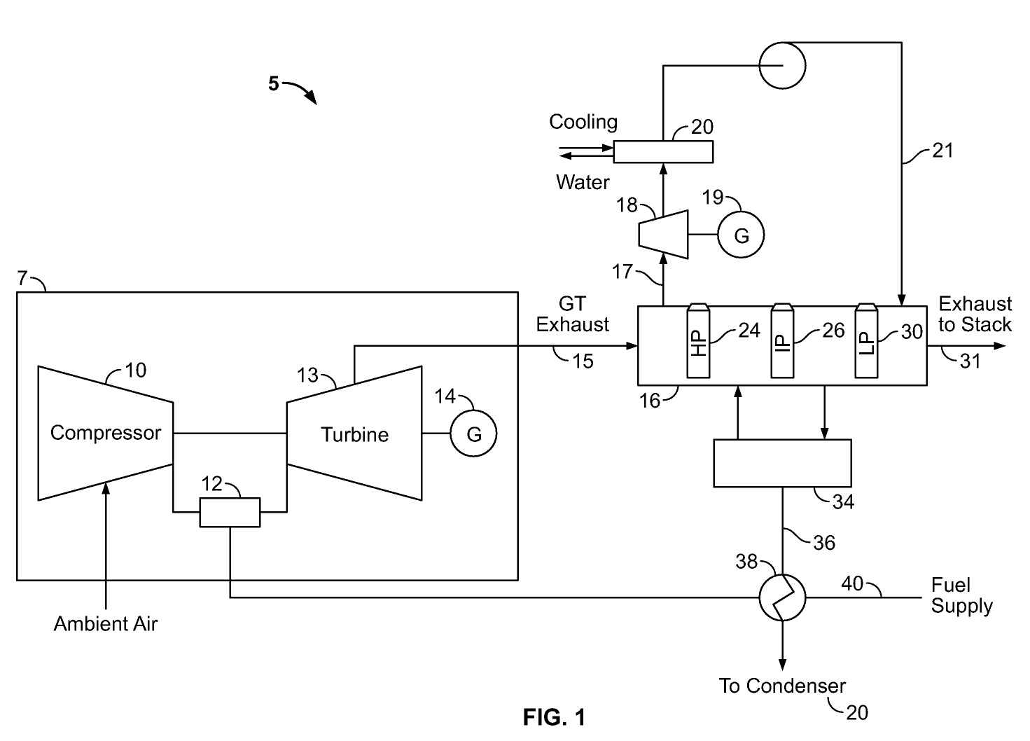

FIG. 1 is a schematic diagram of an exemplary combined cycle power generation system 5. Power generation system includes a gas turbine engine assembly 7 that includes a compressor 10, a combustor 12, and a turbine 13 powered by expanding hot gases produced in the combustor 12 for driving an electrical generator 14. Exhaust gases from gas turbine 13 are supplied through a conduit 15 to a heat recovery steam generator (HRSG) 16 for recovering waste heat from the exhaust gases. HRSG 16 includes high pressure (HP) section 24, intermediate pressure (IP) section 26, and low pressure (LP) section 30. HRSG 16 is configured to transfer progressively lower grade heat from exhaust gases to water circulating through each progressively lower pressure section. Each of the HP, IP, and LP sections 24, 26, and 30 may include an economizer, an evaporator, a superheater and/or feedwater or other pre-heaters associated with the respective section, such as but not limited to a high pressure section pre-heater, which may be split into multiple heat exchangers, which are then positioned in one or more of the sections (HP,IP,LP). The section economizer is typically for pre-heating water before it is converted to steam in for example, the evaporator.

Water is fed to the HRSG 16 through conduit 21 to generate steam. Heat recovered from the exhaust gases supplied to HRSG is transferred to water/steam in the HRSG 16 for producing steam which is supplied through line 17 to a steam turbine 18 for driving a generator 19. Line 17 represents multiple steam lines between the HRSG 16 and steam turbine 18 for the steam produced at different pressure levels. Cooled gases from the HRSG 16 are discharged into atmosphere via exit duct 31 and a stack (not shown).

In the exemplary embodiment, combined-cycle power plant 5 further includes a water heater assembly 34 positioned as a stand alone device separate from HRSG 16. In an alternative embodiment, water heater assembly 34 is positioned within HRSG 16. Water and/or steam are extracted from one or more sections of HRSG and channeled to water heater assembly 34. A flow of fuel heating water 36 is channeled from water heater assembly 34 to a fuel heater 38. A flow of fuel 40 is directed through fuel heater 38 where flow of fuel 40 receives heat transferred from flow of fuel heating water 36. The heated fuel is channeled to combustor 12. The cooled flow of fuel heating water 36 is directed to condenser 20.

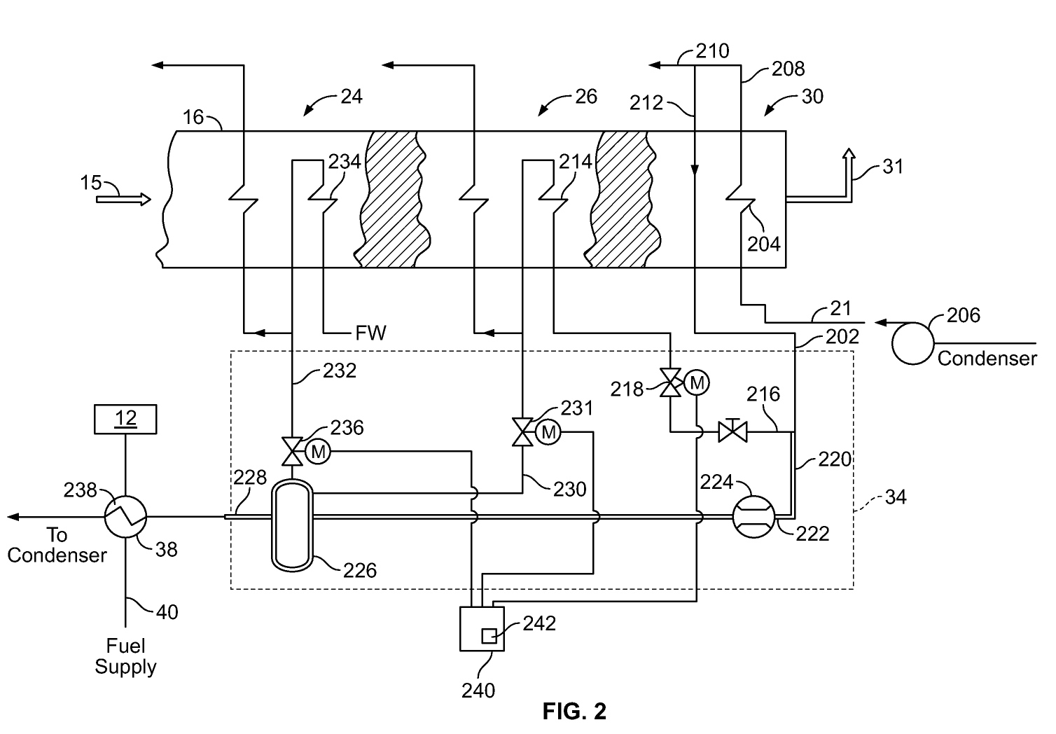

FIG. 2 is a schematic diagram of water heater assembly 34 (shown in FIG. 1) in accordance with an exemplary embodiment of the present invention. In the exemplary embodiment, water heater assembly 34 includes a first inlet configured to receive a flow of at least one of water and steam from a first heat exchanger 204 such as an economizer in LP section 30. In the exemplary embodiment, water is supplied to heat exchanger 204 from a condensate pump 206 through conduit 21. A conduit 208 from an outlet of heat exchanger 204 branches to supply a flow path 210 that channels water heated in heat exchanger 204 to heat exchangers upstream from LP section 30. Conduit 208 also branches into a conduit 212 that channels water from heat exchanger 204 to inlet 202. From inlet 202 the flow path branches to supply water to a heat exchanger 214 in IP section 26 through a conduit 216 and a flow control valve 218. Flow control valve 218 is used to control an amount of flow directed to heat exchanger 214, which controls an amount of heat transferred from heat exchanger 214 to the flow of water. IP section 26 may include other heat exchangers and preheaters positioned upstream, downstream, and/or evenstream with respect to a flow in HRSG 16. The flow of water entering inlet 202 also branches through a conduit 220 to a suction 222 of a booster pump 224. Booster pump 224 provides sufficient head to pump the water through a flash tank mixing vessel 226 to an outlet 228 of water heater assembly 34.

Water heater assembly 34 includes a second flow path 230 into flash tank mixing vessel 226 from heat exchanger 214 through a control valve 231 and a third flow path 232 from a heat exchanger 234 positioned within HP section 24 through a control valve 236. In the exemplary embodiment, only three flow paths are illustrated, however in other embodiments more or less HRSG heat exchangers may be used, which would provide for more or less flow paths into flash tank mixing vessel 226 from heat exchangers in HRSG 16. Additionally, multiple heat exchanger sections may be coupled in flow communication in parallel, series, or combinations thereof to provide a predetermined amount of heat from each section to flash tank mixing vessel 226. Control valves 218, 230, and 236 may be used to modify the heat contribution from each section of HRSG 16 and from various heat exchangers positioned within those sections based on a load of the gas turbine engine 13.

During operation, condensate water is heated through low pressure economizer 204. A portion of the flow through low pressure economizer 204 is channeled to upstream heat exchangers, such as but not limited to a superheater, evaporator, and/or preheaters from other HRSG sections. The remainder of the flow from low pressure economizer 204 is channeled to pump 224 and to flash tank mixing vessel 226 or through control valve 218 to heat exchanger 214. The flow through heat exchanger 214 receives additional higher grade heat from exhaust gas in IP section 26. The flow through heat exchanger 214 is controlled, in the exemplary embodiment, using control valve 231. The flow through heat exchanger 214 is channeled to another inlet of flash tank mixing vessel 226. A flow of feedwater is channeled through heat exchanger 234 positioned in HP section of HRSG 16, control valve 236 and into flash tank mixing vessel 226 through a third inlet. As used herein, flash tank mixing vessel refers to a vessel configured to receive flows of fluid at different grades of heat and combine the flows such that a flow from an outlet of the flash tank mixing vessel is at a temperature and pressure resulting from combining and mixing the received flows. Accordingly, in the exemplary embodiment, system 5 includes a controller 240 configured to control the outlet temperature and pressure of the flash tank mixing vessel using any combination of the inlet flows and may control to outlet temperature and pressure based on a mode of operation of system 5. As used herein, a mode of operation refers to a particular equipment lineup and/or power level output of gas turbine engine 13 and/or steam turbine 18. In the exemplary embodiment, controller 240 includes a processor 242 that is programmable to include instructions for performing the actions described herein. In one embodiment, controller 240 is a stand alone controller. In an alternative embodiment, controller 240 is a subpart or module of a larger controller system such as for example, but not limited to a distributed control system (DCS).

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 242, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is controlling an amount of heat transferred between a multi stage heat exchanger and a flow of fuel. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a system and assemblies for heating a flow of fuel provides a cost-effective and reliable means of improving the efficiency of the power generation system using water heated using progressively higher grade heat from a multi-stage heat exchanger. More specifically, the system and assemblies described herein facilitate improving the efficiency of the power plant by preheating the incoming fuel to a preset temperature. In addition, the above-described system and assemblies facilitate increasing the fuel inlet temperature to the gas turbine combustor such that the amount of fuel required from the combustion process to attain the required combustion temperature is reduced thereby improving the overall efficiency of the power generation cycle. As a result, the system and assemblies described herein facilitate increasing the efficiency of the power generation system in a cost-effective and reliable manner.

An exemplary system and assemblies for heating a flow of fuel using water heated using progressively higher grade heat from a multi-stage heat exchanger are described above in detail. The systems illustrated are not limited to the specific embodiments described herein, but rather, components of each may be utilized independently and separately from other components described herein. Each system component can also be used in combination with other system components.

While the disclosure has been described in terms of various specific embodiments, it will be recognized that the disclosure can be practiced with modification within the spirit and scope of the claims.

What is claimed is:

1. A fuel supply system comprising:
a water heater assembly configured to heat a flow of water by mixing progressively higher grade heated flows of at least one of steam and water from a multi-stage heat exchanger arrangement;
a fuel inlet flow path configured to receive a flow of fuel; and
a fuel heater comprising a first flow path coupled in flow communication with said fuel inlet flow path, said fuel heater comprising a second flow path coupled in flow communication with said water heater assembly, said fuel heater configured to transfer heat from the flow of water to the flow of fuel.

2. A system in accordance with claim 1 wherein said water heater assembly is configured to receive a flow of condensate water from a relatively lower pressure heat exchanger positioned in the multi-stage heat exchanger arrangement.

3. A system in accordance with claim 2 wherein said water heater assembly comprises a first flow path wherein the received flow of condensate water is channeled through a relatively lower pressure heat exchanger positioned within the multi-stage heat exchanger arrangement to a flash tank mixing vessel using a pump.

4. A system in accordance with claim 2 wherein said water heater assembly comprises a second flow path wherein the received flow of condensate water is channeled through a relatively intermediate pressure heat exchanger positioned within the multi-stage heat exchanger arrangement to a flash tank mixing vessel.

5. A system in accordance with claim 4 wherein a temperature of the flow of fuel is controlled using an inlet flow to said intermediate pressure heat exchanger.

6. A system in accordance with claim 1 wherein said water heater assembly is configured to receive a flow of feedwater from a relatively high pressure heat exchanger positioned within the multi-stage heat exchanger arrangement, said water heater assembly comprising a third flow path from the high pressure heat exchanger to the flash tank mixing vessel.

7. A system in accordance with claim 1 wherein said multi-stage heat exchanger arrangement comprises an intermediate pressure section that includes an intermediate pressure heat exchanger positioned downstream of at least one of an intermediate pressure evaporator and an intermediate pressure superheater in a direction of a gas flowpath through the multi-stage heat exchanger arrangement.

8. A system in accordance with claim 1 wherein said multi-stage heat exchanger arrangement comprises a high pressure section that includes a high pressure heat exchanger positioned downstream of at least one of a high pressure evaporator and a high pressure superheater in a direction of a gas flowpath through the multi-stage heat exchanger arrangement.

9. A system in accordance with claim 1 wherein said multi-stage heat exchanger arrangement comprises a low pressure section that includes a low pressure heat exchanger positioned downstream of at least one of a low pressure evaporator and a low pressure superheater in a direction of a gas flowpath through the multi-stage heat exchanger arrangement.

10. A system in accordance with claim 1 wherein said multi-stage heat exchanger arrangement comprises an intermediate pressure section that includes a high or intermediate pressure heat exchanger positioned adjacent to an intermediate pressure heat exchanger and downstream of at least one of an intermediate pressure evaporator and an intermediate pressure superheater in a direction of a gas flowpath through the multi-stage heat exchanger arrangement.

11. A system in accordance with claim 1 wherein said multi-stage heat exchanger arrangement comprises a high pressure section that includes an intermediate pressure heat exchanger positioned adjacent to a high pressure heat exchanger and downstream of at least one of a high pressure evaporator and a high pressure superheater in a direction of a gas flowpath through the multi-stage heat exchanger arrangement.

12. A system in accordance with claim 1 wherein said multi-stage heat exchanger arrangement comprises a low pressure section that includes an intermediate or high pressure heat exchanger positioned adjacent to a low pressure heat exchanger and downstream of at least one of a low pressure evaporator and a low pressure superheater in a direction of a gas flowpath through the multi-stage heat exchanger arrangement.

13. A system in accordance with claim 1 wherein said water heater assembly comprises a pump configured to boost the pressure of the flow of water through a flash tank mixing vessel in said water heater assembly and said second flow path of said fuel heater.

14. A water heater assembly configured to heat a flow of water by mixing progressively higher grade heated flows of at least one of steam and water from a multi-stage heat exchanger arrangement, said water heater assembly comprising:
an inlet configured to receive a flow of condensate water from a relatively lower pressure heat exchanger positioned in the multi-stage heat exchanger arrangement; and
a flash tank mixing vessel comprising a plurality of inlet flow paths and an outlet, said flash tank mixing vessel configured to receive a flow of at least one of steam and water from a respective heat exchanger in the multi-stage heat exchanger arrangement coupled in flow communication to each of the plurality of inlet flow paths.

15. An assembly in accordance with claim 14 wherein a temperature of the flow of condensate water at the outlet is controlled using an inlet flow to at least one of said respective heat exchangers.

16. An assembly in accordance with claim 14 wherein said multi-stage heat exchanger arrangement comprises an intermediate pressure section that includes an intermediate pressure heat exchanger positioned downstream of at least one of an intermediate pressure evaporator and an intermediate pressure superheater in a direction of a gas flowpath through the multi-stage heat exchanger arrangement.

17. An assembly in accordance with claim 14 wherein said water heater assembly further comprising a pump configured to boost the pressure of the flow of water through said water heater assembly to a water heater assembly outlet.

18. A fuel heater assembly configured to heat a flow of water by mixing progressively higher grade heated flows of at least one of steam and water from a multi-stage heat exchanger arrangement, said fuel heater assembly comprising:
a water heater assembly comprising:
a plurality of inlet flow paths configured to receive a flow of at least one of water and steam from respective heat exchangers positioned in the multi-stage heat exchanger arrangement, the respective heat exchangers corresponding to a plurality of different grades of heat in the multi-stage heat exchanger arrangement; and
an outlet configured to channel the heated flow of condensate from the water heater assembly; and
a fuel heater comprising a first flow path configured to be coupled in flow communication with a flow of fuel, said fuel heater comprising a second flow path configured to be coupled in flow communication with said outlet, said fuel heater configured to transfer heat from the flow of water to the flow of fuel.

19. A fuel heater assembly in accordance with claim 18 wherein said multi-stage heat exchanger arrangement comprises an intermediate pressure section that includes an intermediate pressure heat exchanger positioned downstream of an intermediate pressure superheater in a direction of a gas flowpath through the multi-stage heat exchanger arrangement.

20. A fuel heater assembly in accordance with claim 18 wherein said multi-stage heat exchanger arrangement comprises an intermediate pressure section that includes a high or intermediate pressure heat exchanger positioned adjacent to an intermediate pressure heat exchanger and downstream of an intermediate pressure superheater and an intermediate pressure evaporator in a direction of a gas flowpath through the multi-stage heat exchanger arrangement.
